(19) United States
(12) Patent Application Publication
(10) Pub. No.: US 2026/0188283 A1
(43) Pub. Date: Jul. 2, 2026

(54) DISPLAY DRIVING METHOD, DISPLAY DRIVING DEVICE, AND DISPLAY DEVICE

(71) Applicant: TCL CHINA STAR OPTOELECTRONICS TECHNOLOGY CO., LTD., Shenzhen (CN)

(72) Inventors: Jingmin HAN, Shenzhen (CN); Guanxian HE, Shenzhen (CN); Fuping CHENG, Shenzhen (CN); Simin ZHAI, Shenzhen (CN); Weipeng LIAO, Shenzhen (CN); Hao GUO, Shenzhen (CN); Kai WANG, Shenzhen (CN); Jian ZHANG, Shenzhen (CN); Pinyu ZHONG, Shenzhen (CN)

(73) Assignee: TCL CHINA STAR OPTOELECTRONICS TECHNOLOGY CO., LTD., Shenzhen (CN)

(21) Appl. No.: 19/253,857

(22) Filed: Jun. 29, 2025

(30) Foreign Application Priority Data
Dec. 26, 2024 (CN) 202411949685.4

(51) Int. Cl. G09G 5/36

(52) U.S. Cl. CPC G09G 5/36; G09G 2310/08; G09G 2340/0435

(57) ABSTRACT

A display driving method, a display driving device, and a display device are disclosed by the present disclosure. The display driving method includes following steps: augmenting an input video stream to a target video stream, where a refresh rate of the target video stream is greater than a refresh rate of the input video stream; converting each of one or more initial image frames in the target video stream into a target image frame, where a resolution of the target image frame is greater than a resolution of the initial image frame; and driving a display panel to display the target image frame.

### CROSS-REFERENCE TO RELATED APPLICATION

This application claims priority to Chinese Patent Application No. 202411949685.4 filed on Dec. 26, 2024. The entire disclosure of the aforementioned application is herein incorporated by references in its entirety.

### TECHNICAL FIELD

The present disclosure relates to the field of display technologies, and more particularly to a display driving method, a display driving device, and a display device.

### BACKGROUND

With the development of display technologies, requirements of users for display effects have become increasingly demanding. High refresh rate is a key development direction for current display technologies, which can bring users a smooth and coherent visual experience. Especially during processes of e-sports games, display pictures with high refresh rate can significantly improve user's gaming experience. However, in the related technology, the improvement of the refresh rate is at the expense of loss of resolution, and a clarity of the pictures is generally low at a high refresh rate, which affects the display effect.

### SUMMARY

A display driving method, a display driving device, and a display device are provided by the embodiments of the present disclosure, which can realize simultaneous improvement of refresh rate and resolution, and contribute to sufficiently exhibiting high refresh rate and high resolution performances of a display panel.

In a first aspect, a display driving method is provided by the embodiments of the present disclosure. The display driving method includes:
augmenting an input video stream to a target video stream, where a refresh rate of the target video stream is greater than a refresh rate of the input video stream;
converting each of one or more initial image frames in the target video stream into a target image frame, where a resolution of the target image frame is greater than a resolution of the initial image frame; and
driving a display panel to display the target image frame.

In a second aspect, a display driving device is further provided by the embodiments of the present disclosure. The display driving device includes:
a refresh rate adjustment module configured for augmenting an input video stream to a target video stream, where a refresh rate of the target video stream is greater than a refresh rate of the input video stream;
a resolution adjustment module configured for converting each of one or more initial image frames in the target video stream into a target image frame, where a resolution of the target image frame is greater than a resolution of the initial image frame; and
a display driving module configured for driving a display panel to display the target image frame.

In a third aspect, a display device is further provided by the embodiments of the present disclosure. The display device includes a display panel and the display driving device mentioned above.

### BRIEF DESCRIPTION OF THE DRAWINGS

FIG. 1 is a flowchart of a display driving method according to the embodiments of the present disclosure.

FIG. 2 is a block diagram of a display driving device according to the embodiments of the present disclosure.

FIG. 3 is a schematic structural diagram of a field programmable gate array according to the embodiments of the present disclosure.

FIG. 4 is a schematic diagram of a display device according to the embodiments of the present disclosure.

FIG. 5 is a schematic diagram of a gate driving unit according to the embodiments of the present disclosure.

FIG. 6 is a schematic diagram of a driving timing according to the embodiments of the present disclosure.

### DETAILED DESCRIPTION

The technical solutions in the embodiments of the present disclosure will be described hereinafter with reference to the accompanying drawings. The described technical solutions are only used to illustrate and explain the idea of the present disclosure, and should not be regarded as limiting the present disclosure.

In addition, “a plurality of” in the embodiments of the present disclosure refers to two or more. “First”, “second”, etc., in the embodiments of the present disclosure are used to distinguish different technical features, and do not indicate any order, quantity, or importance.

The various embodiments disposed herein are similar, and features in different embodiments may be combined with each other.

The order of description of the following embodiments is not intended to limit the preferred order of the embodiments.

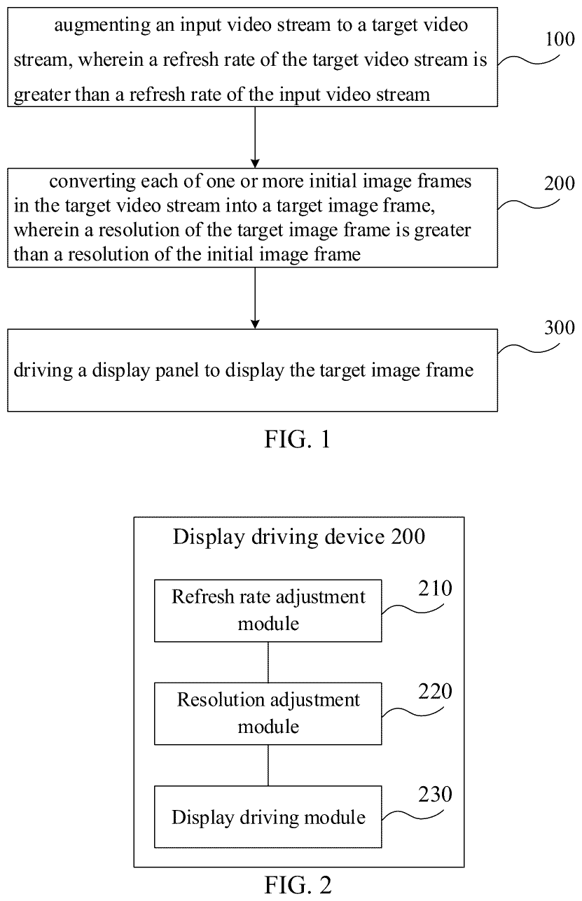

Referring to FIG. 1, FIG. 1 is a flowchart of a display driving method according to the embodiments of the present disclosure. The display driving method includes following steps:
in step 100: augmenting an input video stream to a target video stream, where a refresh rate of the target video stream is greater than a refresh rate of the input video stream;
in step 200: converting each initial image frame in the target video stream into a target image frame, where a resolution of the target image frame is greater than a resolution of the initial image frame; and
in step 300: driving a display panel to display the target image frame.

The input video stream includes at least one image frame. Generally, the input video stream includes a plurality of image frames, and the plurality of image frames are arranged in sequence. The input video stream is augmented to the target video stream in the step 100, so as to increase the refresh rate. The refresh rate of the target video stream is greater than the refresh rate of the input video stream. For example, the refresh rate of the target video stream is 1.5 times, 2 times, 3 times, etc., the refresh rate of the input video stream, and the embodiments of the present disclosure are not limited thereto. In some embodiments, the refresh rate of the input video stream may be compared with the highest refresh rate of the display panel first. Under a condition that the refresh rate of the input video stream is greater than or equal to a highest refresh rate of the display panel, there is no need to improve the refresh rate of the input video stream. Under a condition that the refresh rate of the input video stream is less than the highest refresh rate of the display panel, the step 100 is executed to augment the input video stream into the target video stream. Optionally, the refresh rate of the target video stream is less than or equal to the highest refresh rate of the display panel.

The target video stream includes a plurality of image frames. Since a refresh time of each image frame is shortened due to the improvement of the refresh rate, and the target video stream and the input video stream have a same playback time, a number of the image frames in the target video stream is greater than a number of the image frames in the input video stream. Optionally, a content of the image frame in the target video stream is the same as the content of the image frame in the input video stream, i.e., the target video stream includes each image frame in the input video stream, and the target video stream includes repeated image frames. For additional instructions on improving the refresh rate, please refer to the following embodiments, which will not be described in detail herein.

For convenience of understanding, in the following embodiments, an image frame before resolution conversion is referred to as the initial image frame, and an image frame after resolution conversion is referred to as the target image frame.

In order to improve the resolution, in the step 200, for each initial image frame in the target video stream, the initial image frame is converted into the target image frame. A resolution of the target image frame is greater than a resolution of the initial image frame, e.g., the resolution of the target image frame is 1.2 times, 1.5 times, 2 times, 2.5 times, 3 times, etc., the resolution of the initial image frame, and the embodiments of the present disclosure are not limited thereto. In some embodiments, the resolution of the initial image frame may be compared with the highest resolution of the display panel first. Under a condition that the resolution of the initial image frame is greater than or equal to a highest resolution of the display panel, there is no need to improve the resolution of the initial image frame. Under a condition that the resolution of the initial image frame is less than the highest resolution of the display panel, the step 200 is executed to convert the initial image frame into the target image frame. Optionally, the resolution of the target image frame is less than or equal to the highest resolution of the display panel. In addition, since the resolution of each image frame in one video stream is generally the same, it is possible to compare only the resolution of a first initial image frame with the highest resolution of the display panel without comparing each initial image frame, so as to avoid unnecessary overhead. For additional instructions on improving the resolution rate, please refer to the following embodiments, which will not be described in detail herein.

In the step 300, for each target image frame obtained after the resolution improvement, the display panel is driven to display the target image frame until all target image frames in the target video stream are displayed, and then the playback of the target video stream is completed. It should be understood that the step 200 and the step 300 described above may be executed in a cycle. That is, for the current target image frame in the target video stream, the step 200 is executed first and then the step 300 is executed. During a process of the step 300 being executed for the current target image frame, the step 200 can begin to be executed for the next image frame, and so on.

In summary, in the display driving method provided by the embodiments of the present disclosure, the refresh rate for the input video stream is increased first to obtain the target video stream, then the resolution for each initial image frame in the target video stream is improved to obtain the target image frame, and then the display panel is driven to display the target image frame. As a result, in the embodiments of the present disclosure, the simultaneous improvement of the refresh rate and the resolution can be can realized. While the smoothness of video playback is improved, a clarity of the video playback is also improved, thereby effectively improving the display effect, and contributing to give full play to the high refresh rate and high resolution performance of the display panel.

In some embodiments, the step 100 described above can further include following steps:
in step 110: performing reading processing on N ones of the initial image frames input video S consecutive times respectively to obtain N×S ones of the initial image frames, where N is a positive integer and S is an integer greater than 1; and
in step 120: obtaining the target video stream according to the N×S ones of the initial image frames.

In the step 110, a plurality of consecutive reading processes may be performed for each initial image frame in the input video stream. Alternatively, the plurality of consecutive reading processes may be performed for some of the initial image frames in the input video stream, and a single reading process may be performed for another ones of the initial image frames in the input video stream. That is, the input video stream includes K ones of the initial image frames, where K is a positive integer, and N is a positive integer less than or equal to K. Under a condition that N is a positive integer less than K, the N ones of the initial image frames may be the top N ones of the initial image frames, the bottom N ones of the initial image frames, the middle N ones of the initial image frames, or the random N ones of the initial image frames in a sequence of the image frames of the input video stream. Specific positions of the N ones of the initial image frames are not limited in the embodiments of the present disclosure.

In some embodiments, the refresh rate of the input video stream may be compared with a preset target refresh rate. Under a condition that the refresh rate of the input video stream is less than the target refresh rate, N is equal to K. Under a condition that the refresh rate of the input video stream is greater than the target refresh rate, N is less than K. A specific value of the target refresh rate is not limited in the embodiments of the present disclosure, which can be flexibly set according to requirements in practical applications. Optionally, the target refresh rate is less than or equal to 1/S of the highest refresh rate of the display panel. For example, under a condition that two consecutive reading processes are performed, the target refresh rate may be less than or equal to ½ of the highest refresh rate of the display panel. Under a condition that four consecutive reading processes are performed, the target refresh rate may be less than or equal to ¼ of the highest refresh rate of the display panel.

Under a condition that the reading processing is performed on each initial image frame in the input video stream for S consecutive times in the step 110, i.e., N is equal to K, in the step 120, the target video stream is composed of N×S ones of the initial image frames. Under a condition that in the step 110, the reading processing is performed on some of the initial image frames in the input video stream for S consecutive times, i.e., N is less than K, in the step 120, the target video stream is obtained according to the N×S ones of the initial image frames and K−N ones of the initial image frames. That is, the target video stream is composed of (N×S+K−N) ones of the initial image frames.

It should be understood that a sequence of the image frames of the target video stream is the same as the sequence of the image frames of the input video stream, i.e., a temporal relationship between any two of the initial image frames in the input video stream still holds in the target video stream. For example, the input video stream includes four initial image frames A, B, C, and D. Under the condition that the two consecutive reading processes are performed on each initial image frame, the target video stream includes eight initial image frames A1, A2, B1, B2, C1, C2, D1, and D2. For another example, the input video stream includes four initial image frames A, B, C, and D. Under the condition that two consecutive reading processes are performed on the two initial image frames A and C, and the single consecutive reading process is performed on the initial image frames B and D, the target video stream includes six initial image frames A1, A2, B, C1, C2, and D. A1 and A2 are obtained by performing two consecutive reading processes on A. B1 and B2 are obtained by performing two consecutive reading processes on B. C1 and C2 are obtained by performing two consecutive reading processes on C. D1 and D2 are obtained by performing two consecutive reading processes on D.

In summary, in the display driving method provided by the embodiments of the present disclosure, a plurality of times consecutive reading processes are performed on the same initial image frame, so as to augment a number of the image frames and improve the refresh rate. Furthermore, in the embodiments of the present disclosure, the reading processes for the plurality of consecutive times are performed on each initial image frame or only some of the initial image frames, so as to ensure that the refresh rate of the target video stream is less than or equal to the highest refresh rate of the display panel. That is, it is ensured that the display panel can support the refresh rate of the target video stream, thereby avoiding unnecessary overhead.

In some embodiments, the step 200 described above can includes: performing horizontal interpolation processing on each initial image frames target video stream to obtain the target image frame.

Under a condition that the display panel is driven to display the image frame, the display panel is driven to sequentially display a plurality of rows of sub-pixels in the image frame. As such, in the embodiments of the present disclosure, for each initial image frame in the target video stream, the horizontal interpolation processing is performed on the initial image frame to obtain the target image frame corresponding to the initial image frame. The horizontal interpolation processing includes, but is not limited to, linear interpolation, nonlinear interpolation, bilinear interpolation, nearest neighbor interpolation, etc., and the embodiments of the present disclosure are not limited thereto.

In some embodiments, the step of performing the horizontal interpolation processing on the initial image frame to obtain the target image frame includes: inserting Q ones of the sub-pixels in each sub-pixel row of the initial image frame to obtain the target image frame. Q is a positive integer. In the embodiments of the present disclosure, an insertion position of the Q ones of the sub-pixels is not limited, and the Q ones of the sub-pixels may be randomly inserted in each sub-pixel row, or the Q ones of the sub-pixels may be inserted at a specific position in each sub-pixel row. For example, the Q ones of the sub-pixels are evenly distributed in one sub-pixel row. Optionally, for different sub-pixel rows in the initial image frame, insertion positions of the Q ones of the sub-pixels may be the same or different from each other. Optionally, for the same sub-pixel row in two or more repeated initial image frames, the insertion positions of the Q of the sub-pixels may or may not be the same.

In some embodiments, the display driving method described above further includes: determining the value of Q according to a target resolution and the resolution of the initial image frame. A specific value of the target refresh rate is not limited in the embodiments of the present disclosure, and the target refresh rate can be flexibly set according to requirements in the practical applications. Optionally, the target resolution is less than or equal to the highest resolution of the display panel. The target resolution and the resolution of the initial image frame may both be horizontal resolutions. A sum of the resolution of the initial image frame and the value of Q may be equal to the target resolution.

In summary, in the display driving method provided by the embodiments of the present disclosure, the horizontal interpolation processing is performed to realize the improvement of the resolution. Furthermore, in the embodiments of the present disclosure, according to the comparison between the resolution of the initial image frame and the target resolution, a number of the sub-pixels to be inserted in the horizontal interpolation processing is determined, and the interpolation processing may be performed according to the resolution of the initial image frame, thereby improving the accuracy and efficiency of resolution improvement.

In some embodiments, the step 300 can include following steps:
in step 310: under a condition that the target image frame is an odd-numbered frame in a sequence of image frames of the target video stream, driving the display panel to display odd-numbered rows in sub-pixel rows of the target image frame; and
in step 320: under a condition that the target image frame is an even-numbered frame in a sequence of image frames of the target video stream, driving the display panel to display even-numbered rows in sub-pixel rows of the target image frame.

Each of the sub-pixel rows of the image frame is driven to display by a scanning signal. Switches of sub-pixels in each of the sub-pixel rows are turned on during a duration of a first level of the scanning signal. The switches of the sub-pixels in each of the sub-pixel rows are turned off during a duration of a second level of the scanning signal. The first level is different from the second level. For example, the first level and the second level have opposite polarities. Optionally, the first level is a high level and the second level is a low level. Alternatively, the first level is a low level and the second level is a high level. In the practical applications, a magnitude relationship between the first level and the second level can be determined in combination with a type of each device in a driving circuit of the sub-pixels.

In some embodiments, the step 310 described above may include: driving a T-th one of the sub-pixel rows of the target image frame according to a T-th scanning signal, and driving a (T+1)-th one of the sub-pixel rows of the target image frame according to a (T+1)-th scanning signal. T is a positive integer and T is an odd number, and a level of the (T+1)-th scanning signal is the second level.

In some embodiments, the step 320 described above may include: driving a T-th one of the sub-pixel rows of the target image frame according to a T-th scanning signal, and driving a (T+1)-th one of the sub-pixel rows of the target image frame according to a (T+1)-th scanning signal. T is a positive integer and T is an odd number, and the level of the T-th scanning signal is the second level.

Please refer to the display device in the following embodiments for other descriptions of the step 300, scanning signals, etc., which will not be described in detail herein.

For convenience of better implementing the display driving method provided by the embodiments of the present disclosure, a display driving device is further provided by the embodiments of the present disclosure. The display driving device includes program codes or IP cores. The program codes or the IP cores can be used to execute the above-described display driving method. Nouns have the same meaning as those in the above-described display driving method. For specific implementation details, refer to the description in the embodiments of the display driving method.

Referring to FIG. 2, FIG. 2 is a schematic diagram of a display driving device according to the embodiments of the present disclosure. The program codes or the IP cores in the display driving device may be located in modules as shown in FIG. 2. The display driving device 200 may include a refresh rate adjustment module 210, a resolution adjustment module 220, and a display driving module 230.

The refresh rate adjustment module 210 is configured for augmenting an input video stream to a target video stream. A refresh rate of the target video stream is greater than a refresh rate of the input video stream.

The resolution adjustment 220 module is configured for converting each initial image frame in the target video stream into a target image frame. A resolution of the target image frame is greater than a resolution of the initial image frame.

The display driving module 230 is configured for driving a display panel to display the target image frame.

Optionally, the refresh rate adjustment module 210 is further configured for performing reading processes on N ones of the initial image frames in the input video stream for S consecutive times respectively to obtain N×S ones of the initial image frames, where N is a positive integer and S is an integer greater than 1. The target video stream is obtained according to the N×S ones of the initial image frames.

Optionally, the input video stream includes K ones of the initial image frames, where K is a positive integer. Under a condition that the refresh rate of the input video stream is less than a target refresh rate, the N is equal to the K. Under a condition that the refresh rate of the input video stream is greater than the target refresh rate, N is less than K.

Optionally, N is less than K. The refresh rate adjustment module 210 is further configured for obtaining the target video stream according to the N×S ones of the initial image frames and K−N ones of the initial image frames.

Optionally, the resolution adjustment module 220 is further configured for performing horizontal interpolation processing on each initial image frame in the target video stream to obtain the target image frame.

Optionally, the resolution adjustment module 220 is further configured for inserting Q ones of sub-pixels in each sub-pixel row of the initial image frame to obtain the target image frame, where Q is a positive integer.

Optionally, the resolution adjustment module 220 is further configured for determining the value of Q according to a target resolution and the resolution of the initial image frame.

Optionally, the display driving module 230 is further configured for: driving the display panel to display odd-numbered rows of the sub-pixel rows of the target image frame under a condition that the target image frame is an odd-numbered frame in a sequence of the image frames of the target video stream, and driving the display panel to display even-numbered rows in the sub-pixel rows of the target image frame under a condition that the target image frame is an even-numbered frame in the sequence of the image frames of the target video stream.

Optionally, each of the sub-pixel rows is driven to display by a scanning signal. Switches of sub-pixels in each of the sub-pixel rows are turned on during a duration of a first level of the scanning signal, and the switches of the sub-pixels in each of the sub-pixel rows are turned off during a duration of a second level of the scanning signal. The first level is different from the second level.

Optionally, the display driving module 230 is further configured for: driving a T-th one of the sub-pixel rows of the target image frame according to a T-th scanning signal, and driving a (T+1)-th one of the sub-pixel rows of the target image frame according to a (T+1)-th scanning signal, where T is a positive integer and T is an odd number. A level of the (T+1)-th scanning signal is the second level.

Optionally, the display driving module 230 is further configured for: driving the T-th one of the sub-pixel rows of the target image frame according to the T-th scanning signal, and driving the (T+1)-th one of the sub-pixel rows of the target image frame according to the (T+1)-th scanning signal, where T is a positive integer and T is an odd number. The level of the T-th scanning signal is the second level.

In summary, in the display driving device provided by the embodiments of the present disclosure, the refresh rate for the input video stream is improved to obtain the target video stream first, then the resolution for each initial image frame in the target video stream is improved to obtain the target image frame, and then the display panel is driven to display the target image frame. As a result, in the embodiments of the present disclosure, the simultaneous improvement of the refresh rate and the resolution can be can realized. While the smoothness of video playback is improved, a clarity of the video playback is also improved, thereby effectively improving the display effect, and contributing to give full play to the high refresh rate and high resolution performance of the display panel.

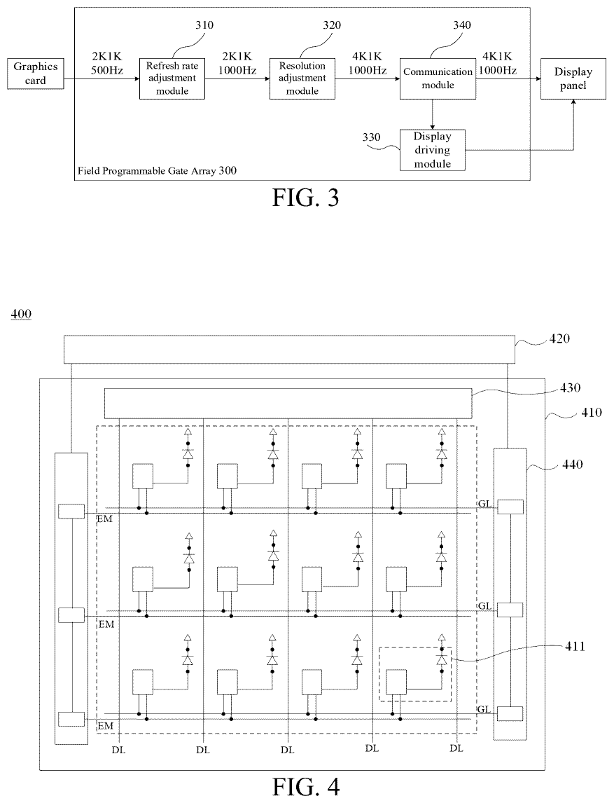

In some embodiments, the display drive device may be implemented as a field programmable gate array (FPGA). Exemplarily, as shown in FIG. 3, the FPGA 300 may include a refresh rate adjustment module 310, a resolution adjustment module 320, a display driving module 330, and a communication module 340 internally. The refresh rate adjustment module 310 may be implemented as the double-data-rate fourth generation synchronous dynamic random access memory (DDR4), and is configured for frequency doubling processing. The resolution adjustment module 320 may be implemented as a horizontal super-resolution (H-SR) for performing horizontal interpolation. The display driving module 330 may be implemented as a driving circuit, such as a gate driving circuit, for driving a display panel. The communication module 340 may be implemented as an XCVR (Transceiver) for data transmission.

As shown in FIG. 3, taking the input video stream with a refresh rate of 500 Hz and a resolution of 2K1K as an example, after acquiring the input video stream from a graphics card, the FPGA 330 first performs frequency multiplication processing by the refresh rate adjustment module 310, reads each initial image frame in the input video stream twice continuously, and then outputs a target video stream having a resolution of 2K1K and a refresh rate of 1000 Hz to the resolution adjustment module 320. The resolution adjustment module 320 performs horizontal interpolation processing on each initial image frame in the target video stream, so that the resolution of the initial image frame is improved from 2K1K to 4K1K to obtain the target image frame, and the resolution adjustment module 320 transmits the target image frame to the communication module 340. The communication module 340 inputs the target image frame into the display panel, and the display panel is driven by the display driving module 330 to display the target image frame.

A person of ordinary skill in the art may understand that the program codes or the IP cores may be stored in one computer readable storage medium, and be loaded and executed by a processor.

To this end, a computer readable storage medium is further provided by the embodiments of the present disclosure. The computer readable storage medium has the program codes or the IP cores stored thereon. The program codes or the IP cores can be loaded by the processor to execute the steps in the display driving method provided by any one of the embodiments of the present disclosure. For example, the program codes or the IP cores can execute following operations including:
augmenting an input video stream to a target video stream, wherein a refresh rate of the target video stream is greater than a refresh rate of the input video stream;
converting each of one or more initial image frames in the target video stream into a target image frame, where a resolution of the target image frame is greater than a resolution of the initial image frame; and
driving a display panel to display each target image frame.

The computer readable storage medium may include a read only memory (ROM), a random access memory (RAM), a magnetic disk, an optical disk, etc.

Since the program codes or the IP cores stored in the computer-readable storage medium can execute the steps in the display driving method provided by any one of the embodiments of the present disclosure, the beneficial effects that can be realized by the display driving method provided by any one of the embodiments of the present disclosure can be realized. Please refer to the embodiments described-above for details, which will not be repeated herein.

A display device is further provided by the embodiments of the present disclosure. The display device includes a display panel and the display driving device in the embodiments mentioned above.

Exemplarily, as shown in FIG. 4, the display device 400 includes a display panel 410, a timing controller 420, a source driving circuit 430, and a gate driving circuit 440. The timing controller 420, the source driving circuit 430, and the gate driving circuit 440 may be integrated into the display driving device. The timing controller and 420 and the source driving circuit 430 are electrically connected, and the timing controller 420 and the gate driving circuit 440 are electrically connected. The display panel 410 includes a plurality of scanning lines GL, a plurality of data lines DL, and a plurality of sub-pixels 411 arranged in an array. The source driving circuit 430 is electrically connected to the data lines DL. The gate driving circuit 440 is electrically connected to the scanning lines GL. Each of the sub-pixel 411 is electrically connected to a corresponding one of the scanning lines GL and a corresponding one of the data lines.

In some embodiments, the gate driving circuit 440 is used for driving a T-th one of the sub-pixel rows of the target image frame according to a T-th scanning signal, and driving a (T+1)-th one of the sub-pixel rows of the target image frame according to a (T+1)-th scanning signal.

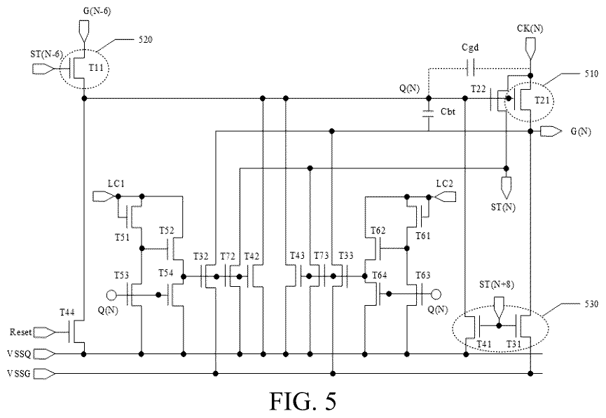

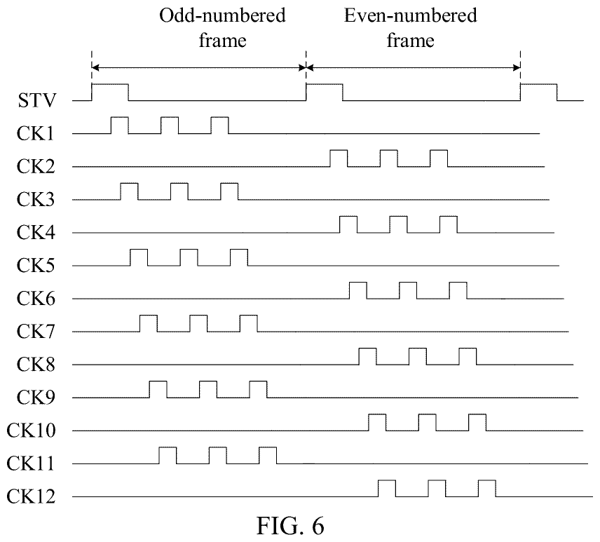

The gate driving circuit 440 includes a plurality of cascaded gate driving units. Each of the gate driving units is connected to a clock signal and outputs a scanning signal. Exemplarily, as shown in FIG. 5, a pull-up module 510 of a N-th stage gate driving unit includes a transistor T21. The transistor T21 is connected to a N-th clock signal CK(N) and outputs a N-th scanning signal G(N). A pull-up control module 520 of the N-th stage gate driving unit includes a transistor T11. The transistor T11 is connected to a (N−6)-th scanning signal G(N−6). A pull-down module 530 of the N-th stage gate driving unit includes a transistor T31 and a transistor T41. The transistor T31 and the transistor T41 are connected to a (N+8)-th scanning signal G(N+8) or a (N+8)-th stage transmission signal ST (N+8).

The display panel 410 in the display device 400 includes at least twelve clock signals from CK1 to CK12. That is, the sub-pixels from a first row of sub-pixels to a twelfth row of sub-pixels in the display panel 410 are divided into a group of sub-pixels. The twelve clock signals are connected to twelve rows of sub-pixels in the group of sub-pixels in one-to-one correspondence through the first scanning lines GL1 to the twelfth scanning lines GL12.

Exemplarily, under a condition that the target image frame is an odd-numbered frame in the sequence of the sub-pixels of the target video stream, the timing controller inputs a driving timing of the gate driving circuit, which may be as shown in FIG. 6. The clock signals CK2, CK4, CK6, CK8, CK10, and CK12 are used to generate the scanning signals transmitted on the scanning lines GL2, GL4, GL6, GL8, GL10, and GL12, respectively, so as to drive even-numbered rows of the sub-pixels. As shown in FIG. 6, the clock signals CK2, CK4, CK6, CK8, CK10, and CK12 are always at a low level in the odd-numbered frames, so that the corresponding scanning signals are always at a low level, and the sub-pixels in even-numbered rows remain turned off, so as to realize the display of the sub-pixels in the odd-numbered rows.

Exemplarily, under a condition that the target image frame is an even-numbered number frame in the sequence of the sub-pixels of the target video stream, the timing controller inputs a driving timing of the gate driving circuit, which may be as shown in FIG. 6. The clock signals CK1, CK3, CK5, CK7, CK9, and CK11 are used to generate the scanning signals transmitted on the scanning lines GL1, GL3, GL5, GL7, GL9, and GL11, respectively, so as to drive the sub-pixels in the odd-numbered rows. As shown in FIG. 6, the clock signals CK1, CK3, CK5, CK7, CK9, and CK11 are always at a low level in even-numbered frames, so that the corresponding scanning signals are always at a low level, and the sub-pixels in the odd-numbered rows remain turned off, so as to realize the display of the sub-pixels in the even-numbered rows.

Beneficial effects of the embodiments of the present disclosure are at least illustrated as follows.

In the display driving method, the display driving device, and the display device provided by the embodiments of the present disclosure, firstly, the refresh rate of the input video stream is increased to obtain the target video stream, then the resolution for each initial image frame in the target video stream is improved to obtain the target image frame, and then the display panel is driven to display the target image frame. As a result, in the embodiments of the present disclosure, the simultaneous improvement of the refresh rate and the resolution can be can realized. While the smoothness of video playback is improved, a clarity of the video playback is also improved, thereby effectively improving the display effect, and contributing to give full play to the high refresh rate and high resolution performances of the display panel.

For specific embodiments of each of the above operations and corresponding beneficial effects, please refer to the above detailed description of the embodiments of the display driving method, and will not be repeatedly described herein.

A display driving method, a display driving device, and a display device provided by the embodiments of the present disclosure have been described in detail above. Specific examples are used in this paper to illustrate the principles and implementation methods of the present disclosure. The description of the above embodiments is only used to help understand the methods and core ideas of the present disclosure. In addition, for those skilled in the art, there will be changes in the specific implementations and the scope of application based on the ideas of the present disclosure. In summary, the content of the description should not be understood as limiting the present disclosure.

What is claimed is:

1. A display driving method comprising:
augmenting an input video stream to a target video stream, wherein a refresh rate of the target video stream is greater than a refresh rate of the input video stream;
converting each of one or more initial image frames in the target video stream into a target image frame, wherein a resolution of the target image frame is greater than a resolution of the initial image frame; and
driving a display panel to display the target image frame.

2. The display driving method according to claim 1, wherein the step of augmenting the input video stream to the target video stream comprises:
performing reading processing on N ones of the initial image frames in the input video stream for S consecutive times respectively to obtain N×S ones of the initial image frames, where N is a positive integer and S is an integer greater than 1; and
obtaining the target video stream according to the N×S ones of the initial image frames.

3. The display driving method according to claim 2, wherein the input video stream includes K ones of the initial image frames, where K is a positive integer;
wherein under a condition that the refresh rate of the input video stream is less than a target refresh rate, N is equal to K; and
wherein under a condition that the refresh rate of the input video stream is greater than the target refresh rate, N is less than K.

4. The display driving method according to claim 3, wherein N is less than K, and the step of obtaining the target video stream according to the N×S ones of the initial image frames comprises:
obtaining the target video stream according to the N×S ones of the initial image frames and K−N ones of the initial image frames.

5. The display driving method according to claim 1, wherein the step of converting each of one or more initial image frames in the target video stream into the target image frame comprises:
performing horizontal interpolation processing on each of the initial image frames in the target video stream to obtain the target image frame.

6. The display driving method according to claim 5, wherein the step of performing the horizontal interpolation processing on each of the initial image frames in the target video stream to obtain the target image frame comprises:
inserting Q ones of sub-pixels in each sub-pixel row of the initial image frame to obtain the target image frame, where Q is a positive integer.

7. The display driving method according to claim 6, wherein the display driving method further comprises:
determining a value of Q according to a target resolution and a resolution of the initial image frame.

8. The display driving method according to claim 1, wherein the step of driving the display panel to display each target image frame comprises:
under a condition that the target image frame is an odd-numbered frame in a sequence of image frames of the target video stream, driving the display panel to display odd-numbered rows in sub-pixel rows of the target image frame; and
under a condition that the target image frame is an even-numbered frame in the sequence of the image frames of the target video stream, driving the display panel to display even-numbered rows in the sub-pixel rows of the target image frame.

9. The display driving method according to claim 8, wherein each of the sub-pixel rows is driven to display by a scanning signal, switches of sub-pixels in each of the sub-pixel rows are turned on during a duration of a first level of the scanning signal, the switches of the sub-pixels in each of the sub-pixel rows are turned off for a duration of a second level of the scanning signal, and the first level is different from the second level.

10. The display driving method according to claim 9, wherein the step of driving the display panel to display the odd-numbered rows in the sub-pixel rows of the target image frame comprises:
driving a T-th one of the sub-pixel rows of the target image frame according to a T-th scanning signal, and driving a (T+1)-th one of the sub-pixel rows of the target image frame according to a (T+1)-th scanning signal;
wherein T is a positive integer and T is an odd number, and a level of the (T+1)-th scanning signal is the second level.

11. The display driving method according to claim 9, wherein the step of driving the display panel to display the even-numbered rows in the sub-pixel rows of the target image frame comprises:
driving a T-th one of the sub-pixel rows of the target image frame according to a T-th scanning signal, and driving a (T+1)-th one of the sub-pixel rows of the target image frame according to a (T+1)-th scanning signal;
wherein T is a positive integer and T is an odd number, and a level of the T-th scanning signal is the second level.

12. A display driving device, comprising:
a refresh rate adjustment module configured for augmenting an input video stream to a target video stream, wherein a refresh rate of the target video stream is greater than a refresh rate of the input video stream;
a resolution adjustment module configured for converting each of one or more initial image frames in the target video stream into a target image frame, wherein a resolution of the target image frame is greater than a resolution of the initial image frame; and
a display driving module configured for driving a display panel to display the target image frame.

13. The display driving device according to claim 12, wherein the refresh rate adjustment module is further configured for:
performing reading processes on N ones of the initial image frames in the input video stream for S consecutive times respectively to obtain N×S ones of the initial image frames, where N is a positive integer and S is an integer greater than 1; and
obtaining the target video stream according to the N×S ones of the initial image frames.

14. The display driving device according to claim 13, wherein the input video stream includes K ones of the initial image frames, where K is a positive integer; under a condition that the refresh rate of the input video stream is less than a target refresh rate, the N is equal to the K; under a condition that the refresh rate of the input video stream is greater than the target refresh rate, the N is less than the K.

15. The display driving device according to claim 14, wherein N is less than K, and the refresh rate adjustment module is further configured for obtaining the target video stream according to the N×S ones of the initial image frames and K−N ones of the initial image frames.

16. The display driving device according to claim 12, wherein the resolution adjustment module is further configured for performing horizontal interpolation processing on each initial image frame in the target video stream to obtain the target image frame.

17. The display driving device according to claim 16, wherein the resolution adjustment module is further configured for inserting Q ones of sub-pixels in each sub-pixel row of the initial image frame to obtain the target image frame, where Q is a positive integer.

18. The display driving device according to claim 17, wherein the resolution adjustment module is further configured for determining a value of Q according to a target resolution and the resolution of the initial image frame.

19. The display driving device according to claim 12, wherein the display driving module is further configured for:
under a condition that the target image frame is an odd-numbered frame in a sequence of the image frames of the target video stream, driving the display panel to display odd-numbered rows of the sub-pixel rows of the target image frame; and
under a condition that the target image frame is an even-numbered frame in the sequence of the image frames of the target video stream, driving the display panel to display even-numbered rows in the sub-pixel rows of the target image frame.

20. A display device, comprising a display panel and a display driving device, wherein the display driving device comprises:
a refresh rate adjustment module configured for augmenting an input video stream to a target video stream, wherein a refresh rate of the target video stream is greater than a refresh rate of the input video stream;
a resolution adjustment module configured for converting each of one or more initial image frames in the target video stream into a target image frame, wherein a resolution of the target image frame is greater than a resolution of the initial image frame; and
a display driving module configured for driving a display panel to display the target image frame.
